(19) United States
(12) Patent Application Publication
(10) Pub. No.: US 2005/0198443 A1
(43) Pub. Date: Sep. 8, 2005

(54) Verification of memory accesses by distal clients by testing memory access by a proximate client

(75) Inventors: Lakshmikanth R. Pai, Bangalore (IN); Manoj Kumar Vajhallya, Bangalore (IN); Jagannath Sathya Narayana Shastry, Bangalore (IN)

Correspondence Address: MCANDREWS HELD & MALLOY, LTD, 500 WEST MADISON STREET, SUITE 3400, CHICAGO, IL, 60661, US

(73) Assignee: Broadcom Corporation

(21) Appl. No.: 10/871,392

(22) Filed: Jun. 18, 2004

Related U.S. Application Data
(60) Provisional application No. 60/542,590, filed on Feb. 5, 2004.

(51) Int. Cl. G06F 13/00

(52) U.S. Cl. 711/147

(57) ABSTRACT

Described herein are systems and methods for verification of memory accesses by distal clients by testing memory access by a proximate client. A proximate client is associated with a first process, wherein the first process causes the proximate client to make a first type of memory access. One or more distal clients are associated with one or more processes, wherein the one or more processes cause the one or more clients to make any of a plurality of memory accesses. The proximate client is operable to make each of the plurality of memory accesses.

### RELATED APPLICATIONS

This application claims priority to “VERIFICATION OF MEMORY ACCESSES BY DISTAL CLIENTS BY TESTING MEMORY ACCESS BY A PROXIMATE CLIENT”, U.S. Provisional Patent Application Ser. No. 60/542,590, filed Feb. 5, 2004, by Ramadas Lakshmikanth Pai, which is incorporated herein by reference for all purposes.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Memory controllers allow clients to make a number of different types of memory accesses to a memory. The most common memory access is what is known as a linear access. A linear access accesses consecutive and continuous addresses of the memory. There are however, more sophisticated memory accesses. For example, a memory may store pixels from a picture in raster order (left to right and top to bottom). A client may seek to access a two-dimensional block from the picture. The two dimensional block will not necessarily be stored in consecutive memory locations. However, a memory controller may allow a client to access blocks from pictures.

During the fabrication and testing of an integrated circuit, the memory accesses are debugged and verified, and this is especially true for more sophisticated memory accesses.

However, in the case where there are multiple clients, some of the clients are located in positions in the integrated circuit that are not easily accessible by testing equipment. Testing the memory accesses by clients that are located in positions of the integrated circuit that are not easily accessible by testing equipment is particularly complex when the clients make memory accesses other than linear accesses.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are systems and methods for verification of memory accesses by distal clients, via testing memory access by a proximate client.

In one embodiment, there is presented a system for accessing memory. The system comprises a proximate client, and one or more distal clients. The proximate client is associated with a first process, wherein the first process causes the proximate client to make a first type of memory access. The one or more distal clients are associated with one or more processes, wherein the one or more processes cause the one or more clients to make any of one or more memory accesses. The proximate client is operable to make each of the one or more memory accesses.

In another embodiment, there is presented a method for verifying a memory in a system comprising a proximate client for making a first type of memory access for a first process, and one or more distal clients for making one of one or more types of memory accesses for one or more processes. The method comprises providing a proximate client with operability to perform each of the one or more types of memory accesses; and monitoring the proximate client.

These and other features and advantages of the present invention may be appreciated from a review of the following detailed description of the present invention, along with the accompanying figures in which like reference numerals refer to like parts throughout.

### BRIEF DESCRIPTION OF SEVERAL VIEWS OF THE DRAWINGS

FIG. 1 is a block diagram of an exemplary integrated circuit in accordance with an embodiment of the present invention;

FIG. 2 is a flow diagram for verifying memory accesses for distal clients, using a proximate client;

FIG. 3 is a block diagram of an exemplary decoder system in accordance with an embodiment of the present invention;

FIG. 4 is a block diagram of an exemplary video decoder in accordance with an embodiment of the present invention; and

FIG. 5 is a block diagram describing the storage of a picture.

### DETAILED DESCRIPTION OF THE INVENTION

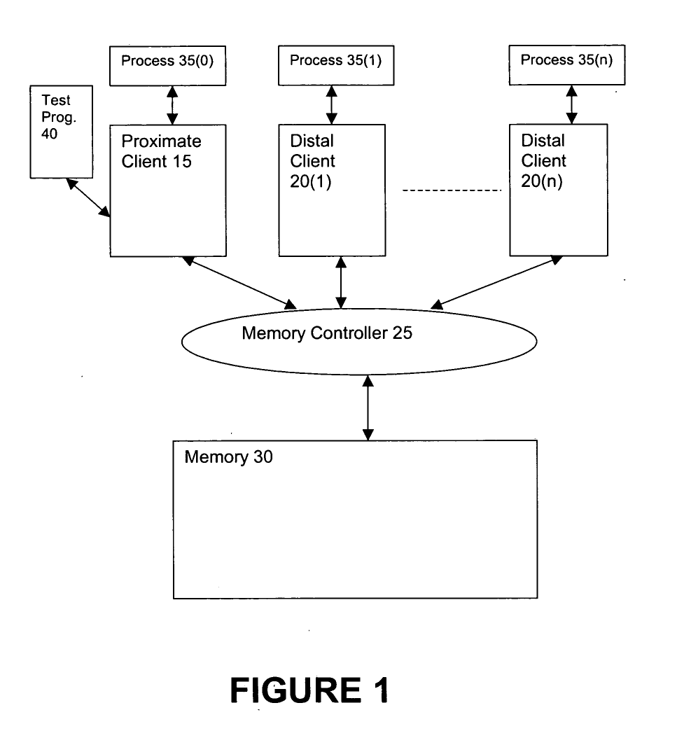

Referring now to FIG. 1, there is illustrated a block diagram describing an exemplary integrated circuit 10, in accordance with an embodiment of the present invention. The integrated circuit 10 comprises a proximate client 15, any number of distal clients 20(1) . . . 20(n), a memory controller 25, and memory 30.

The proximate client 15 and the distal clients 20 can be driven by different processes 35(0) . . . 35(n). Additionally, any combination of the proximate client 15 and the distal clients 20 can be driven by the same process 35, and a proximate client 15 or distal client 20 can be driven by more than one process, although each are illustrated as driven by a single process 35. The proximate client 15 is a client that is easily accessible by outside testing equipment, while the distal clients 20 are not as easily accessible by outside testing equipment. For example, the proximate client 15 can be a port connected to a pin on an integrated circuit.

The memory controller 25 allows the proximate client 15 and the distal clients 20 to make a number of different types of memory accesses to a memory. The accesses can include linear accesses, as well as more sophisticated memory accesses. For example, the memory 30 can store a two dimensional array, wherein the elements of the array are stored from left to right and top to bottom. The memory controller 25 can allow the proximate 15 or a distal client 20 to access a two dimensional block from the two dimensional array.

Due to the processes 35, the particular clients that make the different types of accesses may be distal clients 20. Testing the memory accesses by clients that are located in positions of the integrated circuit that are not easily accessible by testing equipment is particularly complex when the clients make memory accesses other than linear accesses.

However, testing the memory accesses by the proximate client 15 is substantially simpler. Accordingly, the more sophisticated memory accesses can be tested by equipping the proximate client 15 to make the more sophisticated memory accesses, irrespective of the process(es) 35 associated therewith. During testing, a testing program 40 can cause the proximate client 15 to make each of the memory accesses used by all of the distal clients 20. The testing program 40 can either be firmware or driven by external testing equipment or software. The external testing equipment or software can then monitor the operation of the proximate client 15 to verify the memory accesses.

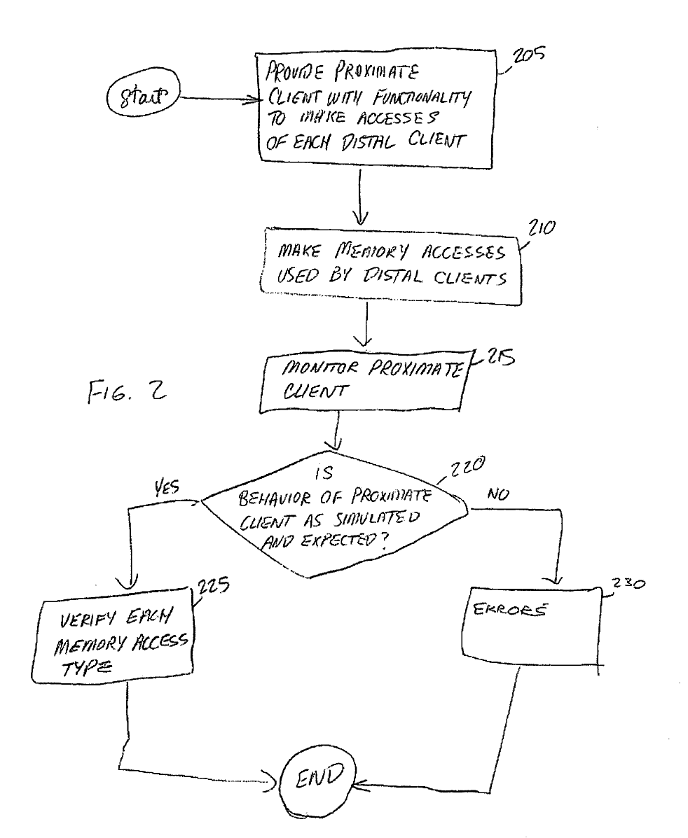

Referring now to FIG. 2, there is illustrated a flow diagram for verifying memory accesses by distal clients using a proximate client. At 205, a proximate client associated with a particular process(es) is provided with the functionality to make the memory access types made by each of the distal clients, irrespective of the type of memory accesses made by the particular process(es).

At 210, a testing program causes the proximate client to make the memory accesses used by the distal clients. At 215, the proximate client is monitored and the behavior of the proximate client is compared (220) to simulated and expected behavior for the distal clients while make the same type of memory accesses. If the proximate client's behavior is the same as simulated and expected, each of the memory access types is verified (225). If the proximate client's behavior is not the same as simulated and expected, there are errors in the memory controller or memory system (230).

Testing memory accesses of distal clients by monitoring the memory accesses of proximate clients can be used to verify memory accesses in a decoder system. In a decoder system, pictures can be stored in raster order, wherein pixels in rows from top to bottom are stored from left to right in consecutive memory locations. Some clients may need to access a two-dimensional block of pixels. A pixel reconstructor reconstructs pixels from a block of reference pixels of another picture in a video frame. Accordingly, a memory controller can allow a video request manager to fetch a two dimensional block from the memory for the pixel reconstructor. The foregoing is known as a macroblock read access. Additionally, the video request manager may write a block to memory in non-consecutive locations in what is known as a macroblock write access.

It may be beneficial to verify the memory controller ability to perform a macroblock read/write accesses. However, the video request manager may be a distal client that is not easily accessible. However, another client, the video direct memory access module may be a proximate client that is more easily accessible. Accordingly, irrespective of whether the video direct memory access module is associated with a process that uses macroblock read/write accesses, the video direct memory access module can be equipped to perform macroblock read/write accesses.

During testing, a testing program can cause the video direct memory access to make macroblock read accesses used by the video request manager. External testing equipment or software can then monitor the operation of the proximate client 15 to verify the memory access.

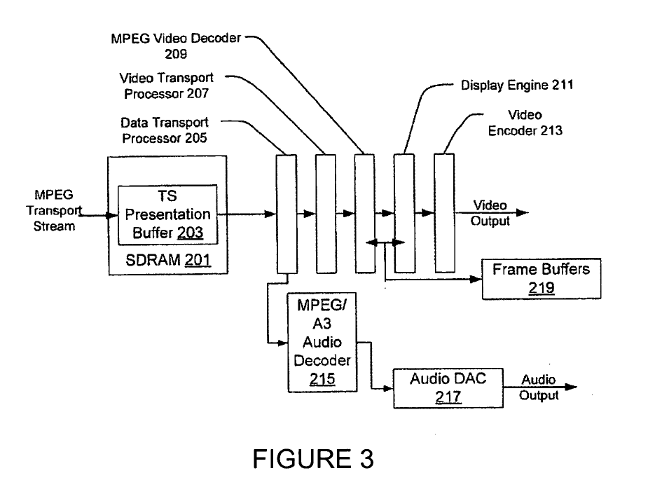

FIG. 3 illustrates a block diagram of an exemplary circuit for decoding compressed video data, in accordance with an embodiment of the present invention. Data is received and stored in a presentation buffer 203 within a Synchronous Dynamic Random Access Memory (SDRAM) 201. The data can be received from either a communication channel or from a local memory, such as, for example, a hard disc or a DVD.

The data output from the presentation buffer 203 is then passed to a data transport processor 205. The data transport processor 205 demultiplexes the transport stream into packetized elementary stream constituents, and passes the audio transport stream to an audio decoder 215 and the video transport stream to a video transport processor 207 and then to a MPEG video decoder 209. The audio data is then sent to the output blocks, and the video is sent to a display engine 211.

The video decoder 209 decodes at least one picture from the video during a display period. After the video decoder 209 decodes a picture, the video decoder 209 writes the picture into a frame buffer 220. The display engine 211 scales the video picture, renders the graphics, and constructs the complete display. Once the display is ready to be presented, it is passed to a video output encoder 213 where it is converted to analog video using an internal digital to analog converter (DAC). The digital audio is converted to analog in an audio digital to analog converter (DAC) 217.

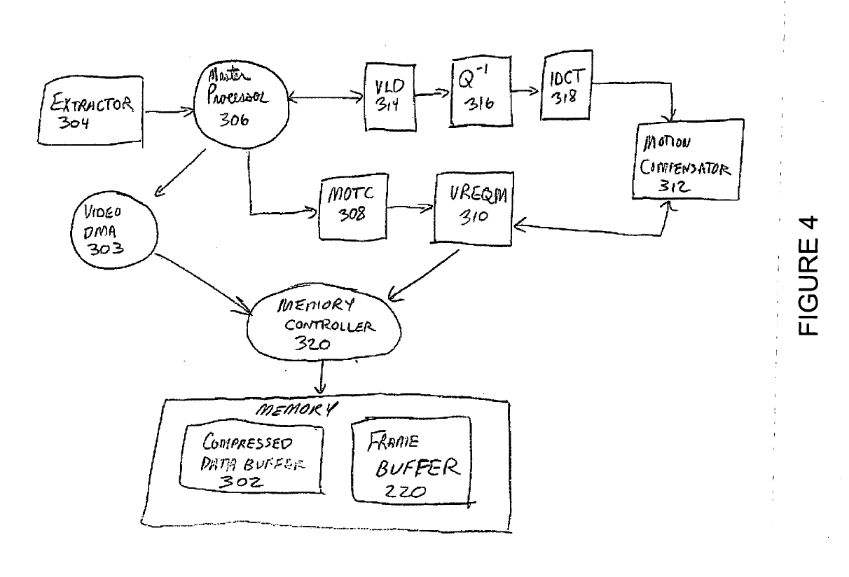

Referring now to FIG. 4, there is illustrated a block diagram of an exemplary video decoder 209 in accordance with an embodiment of the present invention. The video decoder 209 comprises a compressed data buffer 302, an extractor 304, a processor 306, a motion vector address computer 308, a video request manager 310, a motion compensator 312, a variable length decoder 314, an inverse quantizer 316, and an inverse discrete cosine transformation module 318.

The compressed data buffer 302 stores the data for decoding a picture. The video decoder 209 fetches data from the compressed data buffer 302, via a video direct memory access module 303 and extractor 304 that provides the fetched data to a processor 306. The foregoing is accomplished using linear accesses to the compressed data buffer 302 via memory controller 320. At least a portion of the data forming the picture is encoded using variable length code symbols. Accordingly, the variable length coded symbols are provided to a variable length decoder 314.

The processor 306 provides the data for decoding a picture to the inverse quantizer 316 and the Inverse Discrete Cosine Transformation (IDCT) module 318. In many pictures, the processed data from the IDCT module 318 represents an offset between a portion of a picture (the portion of the picture is known as a macroblock) and reference pixels from another previously decoded picture(s). Where the data from the IDCT module 318 represents an offset between a portion of a picture and reference pixels from another previously decoded picture(s), the video request manager 310 fetches the reference pixels from the another picture(s). As noted above, the another picture(s) are stored in a frame buffer 220.

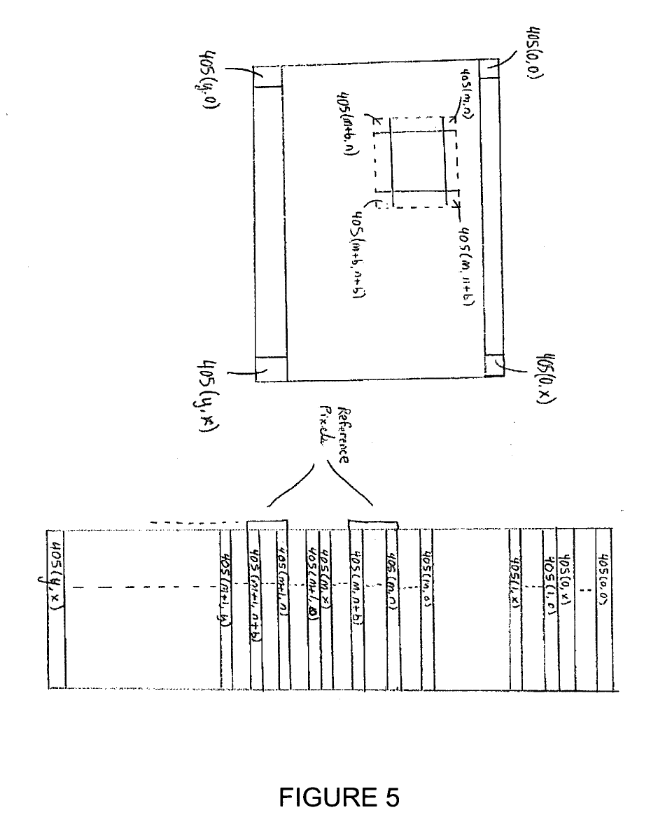

Referring now to FIG. 5, there is illustrated a block diagram describing the storage of a picture in a frame buffer. A picture comprises a two-dimensional grid of pixels 405(0,0) . . . 405(0,x), . . . , 405(y,0) . . . 405(y,x). As noted above, a portion of a picture can be predicted from a block of reference pixels 405(m,n) . . . 405(m+b,n), . . . 405(m+b,n) . . . 405(m+b,n+b).

The frame buffer 220 stores the picture in raster scan order, starting from the top row 405(0,0) . . . 405(0,x), and proceeding downwards to the bottom row 405(y,0) . . . 405(y,x). As can be seen, the block of reference pixels 405(m,n) . . . 405(m+b,n), . . . 405(m+b,n) . . . 405(m+b,n+b) are not stored in consecutive memory locations.

Referring again to FIG. 4, which will now be described in conjunction to FIG. 5, the video request manager 310 fetches the reference pixels 405(m,n) . . . 405 (m+b,n), . . . 405(m+b,n) . . . 405(m+b, n+b) from the frame buffer 220. However, as noted above, the reference pixels 405(m,n) . . . 405(m+b,n), . . . 405(m+b,n) . . . 405(m+b,n+b) are not located in consecutive memory locations. Accordingly, the memory controller 320 allows the video request manager 310 to fetch the reference pixels 405(m,n) . . . 405(m+b,n), . . . 405(m+b,n) . . . 405(m+b,n+b), using a special memory access, known as a macroblock read.

The video request manager 310 then provides the reference pixels 405(m,n) . . . 405(m+b,n), . . . 405(m+b,n) . . . 405(m+b,n+b) to the motion compensator 312. The motion compensator 312 applies the data from the IDCT 318 to the reference pixels 405(m,n) . . . 405(m+b,n), . . . 405(m+b,n) . . . 405(m+b,n+b), thereby recovering the macroblock.

The video request manager 310 then writes the macroblock to the frame buffer 220. The macroblock is a two-dimensional block of pixels. However, the video request 310 may not write the macroblock to consecutive memory locations. As noted above, the video request manager 310 may write the picture in raster order. Like the reference pixels 405(m,n) . . . 405(m+b,n), . . . 405(m+b,n) . . . 405(m+b,n+b), the macroblock is not necessarily contiguous in raster order. Accordingly, the memory controller allows the video request manager 310 to perform what is known as a macroblock write.

It may be beneficial to verify the memory controller's ability to perform a macroblock read/write access. However, the video request manager may be a distal client that is not easily accessible. However, the video direct memory access module may be a proximate client that is more easily accessible. Accordingly, albeit that providing data from the compressed data buffer 302 to the processor 306 uses linear memory accesses, the video direct memory access module 303 can be equipped to perform macroblock read/write accesses.

During testing, a testing program can cause the video direct memory access module 303 to make macroblock read/write accesses used by the video request manager 310. External testing equipment or software can then monitor the operation of the video direct memory access module 303 to verify the memory access.

The embodiments described herein may be implemented as a board level product, as a single chip, application specific integrated circuit (ASIC), or with varying levels of the decoder system integrated with other portions of the system as separate components. The degree of integration of the decoder system will primarily be determined by the speed and cost considerations. Because of the sophisticated nature of modern processor, it is possible to utilize a commercially available processor, which may be implemented external to an ASIC implementation. Alternatively, if the processor is available as an ASIC core or logic block, then the commercially available processor can be implemented as part of an ASIC device wherein certain functions can be implemented in firmware.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A system for accessing memory, said system comprising:
a proximate client for making a first type of access, the proximate client associated with a first process, wherein the first process causes the proximate client to make the first type of memory access;
one or more distal clients for making any of one or more memory accesses, the distal clients associated with one or more processes, wherein the one or more processes cause the one or more clients to make any of one or more memory accesses; and
wherein the proximate client is operable to make each of the one or more memory accesses.

2. The system of claim 1, wherein the first type of memory access comprises a linear memory access and wherein the one or more memory accesses comprise one or more non-linear memory accesses.

3. The system of claim 1, wherein the one or more memory accesses comprise a macroblock read access.

4. The system of claim 1, wherein the one or more memory access comprises a macroblock write access.

5. The system of claim 1, wherein the proximate client comprises a video direct memory access module.

6. The system of claim 1, wherein the one or more distal clients comprise a video request manager.

7. A method for verifying a memory, in a system comprising a proximate client for making a first type of memory access for a first process, and one or more distal clients for making one of one or more types of memory accesses for one or more processes, said method comprising:
providing a proximate client with operability to perform each of the one or more types of memory accesses; and
monitoring the proximate client.

8. The method of claim 7, wherein the first type of memory access comprises a linear memory access and wherein the one or more memory accesses comprise one or more non-linear memory accesses.

9. The method of claim 7, wherein the one or more memory accesses comprise a macroblock read access.

10. The method of claim 7, wherein the one or more memory access comprises a macroblock write access.

11. The method of claim 7, wherein the proximate client comprises a video direct memory access module.

12. The method of claim 7, wherein the one or more distal clients comprise a video request manager.

13. The method of claim 7, further comprising:
verifying the first type of memory access and each of the one or more memory accesses based on monitoring the proximate client.
